(19) United States
(12) Patent Application Publication
(10) Pub. No.: US 2015/0001109 A1
(43) Pub. Date: Jan. 1, 2015

(54) Packaging

(71) Applicant: British American Tobacco (Investments) Limited, London, LO (GB)

(72) Inventors: Paul Gibson, London (GB); Robert Whiffen, London (GB)

(21) Appl. No.: 14/377,624

(22) PCT Filed: Feb. 13, 2013
(86) PCT No.: PCT/EP2013/052868

§ 371 Date: Aug. 8, 2014

(30) Foreign Application Priority Data
Feb. 13, 2012 (GB) 1202449.3

(51) Int. Cl. B65D 85/10; B65D 75/58; B31D 1/00

(52) U.S. Cl. CPC B65D 85/1027; B31D 1/0075; B65D 75/5827; B31D 2201/00
USPC 206/264; 493/346; 493/345; 229/87.05; 229/87.13

(57) ABSTRACT

A wrapper (10) comprising a film (11) having a reinforcing tear strip (12) extending at least partially across the film. The tear strip (12) includes an incision (17). No lines of weakening are provided in the tear strip to assist the tearing thereof other than the incision (17). The wrapper is configured such that, when a first portion of the tear strip (12) on one side of the incision (17) is pulled away from a second portion of the tear strip (12) on the other side of the incision, a tear will propagate from the incision along the length of the tear strip (12) and through the film (11) so that the tear strip and film separate into two portions (11a, 11b) with a first portion (11a) of the film attached to the first tear strip portion, and a remaining, second portion (11b) of the film attached to the second tear strip portion.

### TECHNICAL FIELD

The present invention relates to packaging and, more particularly, wrappers for packaging and packaging including such wrappers.

### BACKGROUND

Packaging is known which includes a sealed outer wrapper to be removed upon initial opening of the packaging. Such wrappers may include a tear-off strip to aid removal of the wrapper and which separates the wrapper into two portions, at least one of which is to be removed from the pack. The tear strip may remain adhered to one portion of the separated wrapper so that it is removed from the pack, leaving the other portion of the separated wrapper in place over a portion of the pack.

### SUMMARY

In accordance with embodiments of the invention, there is provided a wrapper comprising a film having a reinforcing tear strip extending at least partially across the film, the tear strip including an incision, and wherein no lines of weakening are provided in the tear strip to assist the tearing thereof other than the incision, the wrapper configured such that, when a first portion of the tear strip on one side of the incision is pulled away from a second portion of the tear strip on the other side of the incision, a tear will propagate from the incision along the length of the tear strip and through the film so that the tear strip and film separate into two portions with a first portion of the film attached to the first tear strip portion, and a remaining, second portion of the film attached to the second tear strip portion.

The film may comprise a first side and a second, opposite side, and the reinforcing tear strip extends from the first side of the film, and the incision may be formed proximate the first side of the film.

The film may comprise a second side opposite said first side, and the tear strip may extend entirely across the film from the first side to the second side. Alternatively, the tear strip may extend only partially across the film from the first side towards the second side.

The tear strip may include at least one tab portion projecting from the first side of the film, and may include two tab portions, one disposed either side of the incision. The two tab portions may together define a substantially ‘m’ shaped end of the tear strip.

The cut may comprise a substantially v-shaped nick in the tear strip.

The tear strip may be adhered to the film. The tear strip may comprise an oriented material, and/or the material of the wrapper may comprise an oriented film.

The wrapper may comprise only one single tear strip.

The invention also provides a package comprising at least one container enveloped in a wrapper as described above, wherein the wrapper can be entirely removed from the pack by pulling a first portion of the tear strip to propagate a tear from the incision along the length of the tear strip and through the film to remove a first portion of the film attached to the first tear strip portion, and the remaining, second portion of the film can be removed from the pack by pulling away with the second tear strip portion.

The invention also provides a wrapper comprising a film having a plurality of reinforcing tear strips extending at least partially across the film, each tear strip including tab portion, the wrapper configured such that pulling the tab of a first tear strip causes a tear to propagate through the film to separate a first portion of the film attached to the first tear strip, from the remainder of the film, and pulling the tab of a second tear strip causes a second tear to propagate through the film to define a second portion of the film attached to the second tear strip.

The first and second tear strips may be spaced from each other such that a third portion of the film is defined between them and which remains when the first and second tear strips are pulled to separate the first and second portions of the film, attached to the first and second tear strips respectively, from the third portion of the film.

The tabs and the first and second tear strips may be configured so that the tear each tear strip causes in the film when the respective tab is pulled, extends in a substantially opposite direction to each other.

The film may comprise a first side and a second, opposite side, and the reinforcing tear strips extend from one of the first and second sides of the film.

The tabs of the first and second tear strips may be located on opposite sides of the film so that the tear each tear strip causes in the film when the respective tab is pulled, extends in a substantially opposite direction to each other.

A line of weakening may be formed in the film between the first and second tear strips.

Each tab portion may be delimited from the respective film edge by an incision.

The tear strips may be adhered to the film.

The invention also provides a package comprising at least one container enveloped in a wrapper as described above.

The invention also provides a pack enveloped in a wrapper as described above, wherein the pack is parallelepiped and comprises a base and a hinged lid which defines a shut line on a front face of the pack, wherein the first tear strip is disposed on one side of the shut line and the second tear strip is disposed on an opposite side of the shut line such that when the first and second portions of the film are removed, the third portion remains on the pack overlying the shut line preventing the hinged lid being pivoted open.

The invention also provides a package comprising at least one container enveloped in a wrapper, the wrapper comprising a film with overlapping portions which are sealed together, wherein a pull tab is defined in the film in the region of the overlapping portions to facilitate removal of the wrapper by pulling the tab to initiate tearing of the film, and wherein the seal is weakened or interrupted in the region of the pull tab.

The package may comprise a plurality of pull tabs formed in the film in the region of the overlapping portions.

The seal may be weakened by being of reduced width in the region of the, or at least one of the, pull tab(s), or may be entirely interrupted in the region of the, or at least one of the, pull tab(s).

At least one incision may be formed in the film adjacent the or each pull tab to facilitate initiating of the tear in the film when the or each pull tab is pulled.

The invention also provides a wrapper comprising a film having a plurality of lines of weakening formed in a repeating pattern over at least a portion of the surface area of the film, the wrapper configured such that a portion of the film can be separated from a remaining portion of the film by tearing the film and the tear propagating along the lines of weakening.

The repeating pattern may comprise a pattern of tessellating polygons.

The lines of weakening may be unequally weak such that an intended tear path of the film is defined by one or more lines of increased weakening relative to the remaining lines of weakening.

An edge of the film comprising an intended tear initiation point may include one or more pull tabs, which may comprise a label printed or adhered onto the film.

The invention also provides a package comprising at least one container enveloped in a wrapper as described above.

The film may comprise an oriented film.

The invention also provides an apparatus for manufacturing a wrapper for packaging, comprising a supply of film and a supply of reinforcing tear strip material, a pair of rollers through which the film and tear strip material can be fed together to affix the tear strip material to the film, and one or more cutting knives configured to form cuts intermittently through the tear strip and the film as the film is conveyed past the cutting knife/knives, wherein the cutting knife/knives are configured to form linear cuts transversely through the film to divide the film into individual wrappers, and to form tab cuts in the tear strip material proximate the linear cuts to define first and second tab portions at one end of the tear strip of each wrapper, and also form an incision in the tear strip material between each first and second tab portion, and wherein no lines of weakening are provided in the tear strip to assist the tearing thereof other than the incision.

The incision formed between the first and second tab portions may be configured to enable a tear to propagate from the incision along the length of the tear strip and through the film when the first tab portion is pulled away from the second tab portion.

The apparatus may be configured to form the tab cuts and first and second tab portions in a single reinforcing tear strip.

The apparatus may be configured to form the tab cuts extending across the edges of the tear strip into the film adjacent the tear strip.

The apparatus may be configured to form the linear cuts intersecting the tab cuts in the region of the film adjacent the tear strip, but not to extend into the tear strip. The cutting knife/knives may be configured to form substantially ‘m’ shaped tab cuts.

The invention also provides an apparatus for manufacturing a wrapper for packaging, comprising a supply of film and a supply of reinforcing tear strip material, a pair of rollers through which the film and tear strip material can be fed together to affix two separate portions of tear strip material on the film, and one or more cutting knives configured to form cuts intermittently through the tear strips and the film as the film is conveyed past the cutting knife/knives, wherein the cutting knife/knives are configured to form linear cuts transversely through the film to divide the film into individual wrappers, and to form tab cuts in the tear strips proximate the linear cuts to define a tab portion at one end of each tear strip of each wrapper.

The apparatus may be configured to provide the pair of tear strips in parallel along the film and transversely spaced from each other.

The apparatus may be configured to form the tab cuts extending across the edges of the tear strips into the film adjacent the tear strips.

The apparatus may be configured to form the linear cuts intersecting the tab cuts in the region of the film adjacent the tear strips, but not to extend into the tear strips.

The invention also provides a method of manufacturing a wrapper for packaging comprising applying a reinforcing tear strip to a film, forming linear cuts transversely through the film to divide the film into individual wrappers, forming tab cuts in the tear strip material proximate the linear cuts to define first and second tab portions at one end of the tear strip of each wrapper, and forming an incision in the tear strip material between each first and second tab portion, and wherein and no line of weakening is provided in the tear strip to assist the tearing thereof other than the incision.

The method may comprise forming the tab cuts and first and second tab portions in a single reinforcing tear strip.

The method may comprise forming the tab cuts extending across the edges of the tear strip into the film adjacent the tear strip.

The method may comprise forming the linear cuts intersecting the tab cuts in the region of the film adjacent the tear strip, but not extending into the tear strip.

The method may comprise forming substantially ‘m’ shaped tab cuts.

The invention also provides a method of manufacturing a wrapper for packaging comprising applying two separate portions of a reinforcing tear strip material to a film, forming linear cuts transversely through the film to divide the film into individual wrappers, forming tab cuts in the tear strips proximate the linear cuts to define a tab portion at one end of each tear strip of each wrapper.

The method may comprise providing the tear strips in parallel along the film and transversely spaced from each other.

The method may comprise forming the tab cuts extending across the edges of the tear strips into the film adjacent the tear strips.

The method may comprise forming the linear cuts intersecting the tab cuts in the region of the film adjacent the tear strips, but not extending into the tear strips.

The invention also provides a method of manufacturing a packaging comprising enveloping at least one container with a wrapper, overlapping the wrapper along one side of the at least one container, and sealing the overlapping portions together, forming a pull tab in the region of the overlapping portions to facilitate removal of the wrapper by pulling the tab to initiate tearing of the film, and forming the seal with a weakened or interrupted region in the area of the pull tab.

The method may comprise forming the seal with a reduced width at the weakened region or forming the seal by interrupting the seal at the weakened region.

### BRIEF DESCRIPTION OF THE DRAWINGS

Embodiments of the invention will now be described, by way of example only, with reference to the accompany drawings, in which:

FIG. 1A shows a wrapper of a first embodiment of the invention;

FIG. 1B shows a variant of the wrapper the first embodiment of the invention;

FIG. 2 shows a pack including the wrapper of FIG. 1 fully wrapped therearound;

FIG. 3 shows the pack of FIG. 2 with the wrapper in a first partially un-wrapped state;

FIG. 4 shows the pack of FIGS. 2 and 3 with the wrapper in a second partially un-wrapped state;

FIG. 5 shows a wrapper of a second embodiment of the invention;

FIG. 6 shows a pack including the wrapper of FIG. 5 fully wrapped therearound;

FIG. 7 shows the pack of FIG. 6 with the wrapper in a first partially un-wrapped state;

FIG. 8 shows the pack of FIGS. 6 and 7 with the wrapper in a second partially un-wrapped state;

FIG. 9 shows a pack including a wrapper of a third embodiment of the invention partially unwrapped therefrom;

FIG. 10 shows a pack including a wrapper of a fourth embodiment of the invention partially unwrapped therefrom;

FIG. 11A shows the pack of FIG. 10 with a first tear strip and upper portion of the film wrap removed therefrom and a second tear strip partially removed;

FIG. 11B shows the pack of FIG. 11A with a middle portion of the film wrap displaced on the pack;

FIG. 12 shows a pack including a wrapper of a fifth embodiment of the invention partially unwrapped therefrom;

FIG. 13 shows a pack including a wrapper of a sixth embodiment of the invention including a portion of a heat sealing apparatus;

FIG. 14 shows a pack including a wrapper of a seventh embodiment of the invention partially unwrapped therefrom;

FIG. 15 shows alternative configurations of tear portions applicable to the wrapper of the seventh embodiment of the invention shown in FIG. 14;

FIG. 16 shows a schematic drawing of an apparatus for manufacturing a wrapper of the first embodiment of the invention, and enveloping a pack with such a wrapper;

FIG. 17 shows a first view of a portion of the wrapper of the first embodiment of the invention part-way through the manufacturing process;

FIG. 18A shows a second view of a portion of a first variant of the wrapper of the first embodiment of the invention part-way through the manufacturing process;

FIG. 18B shows a second view of a portion of a second variant of the wrapper of the first embodiment of the invention part-way through the manufacturing process;

FIG. 19A shows a first variant of a first cutting roller of the apparatus of FIG. 16;

FIG. 19B shows a second variant of a first cutting roller of the apparatus of FIG. 16;

FIG. 20 shows a second cutting roller of the apparatus of FIG. 16;

FIG. 21 shows a schematic drawing of an apparatus for manufacturing a wrapper of the fourth embodiment of the invention, and enveloping a pack with such a wrapper;

FIG. 22 shows a first view of a portion of the wrapper of the fourth embodiment of the invention part-way through the manufacturing process;

FIG. 23 shows a second view of a portion of a the wrapper of the fourth embodiment of the invention part-way through the manufacturing process;

FIG. 24 shows a first cutting roller of the apparatus of FIG. 21; and

FIG. 25 shows a second cutting roller of the apparatus of FIG. 21.

### DETAILED DESCRIPTION

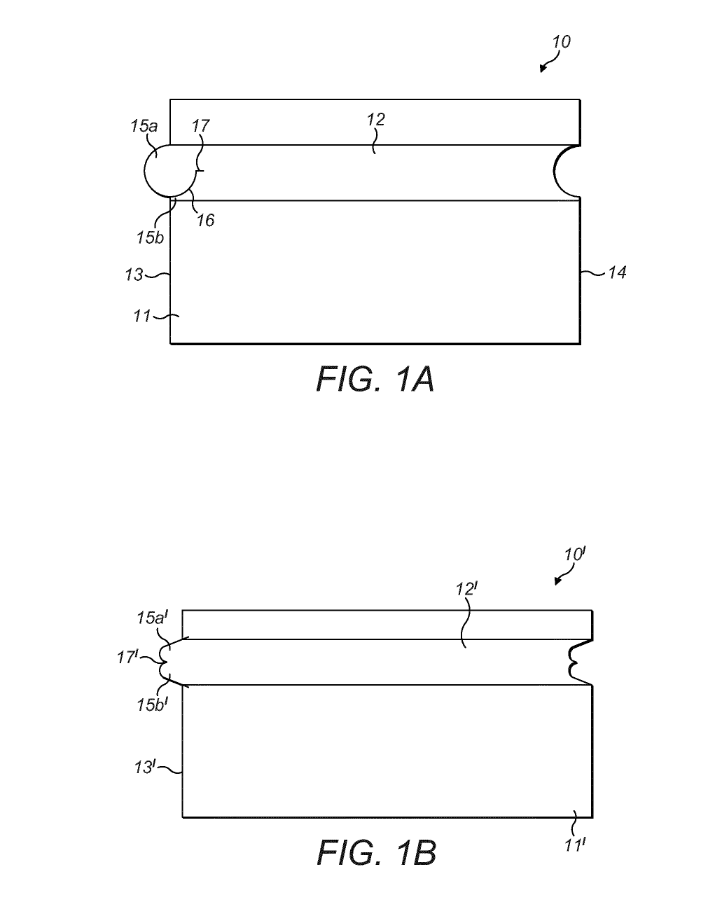

Referring now to FIG. 1, a wrapper 10 of a first embodiment of the invention is shown and comprises a film 11 and a tear strip 12 permanently adhered thereto and extending across the film 11 from a first side 13 to a second, opposite side 14. The tear strip 12 is configured with a major tab portion 15a which extends beyond the first side 13 of the film 11. In the embodiment shown, the major tab portion 15a is generally circular and is partially separated from the remainder of the tear strip 12 by an arcuate cut 16. This defines a minor tab portion 15b at the end of the tear strip 12 below the generally circular major tab portion 15a. A nick or small straight cut 17 extends a small distance from the end of the arcuate cut 16 in a longitudinal direction of the tear strip 12 towards the second side 14 of the film 11.

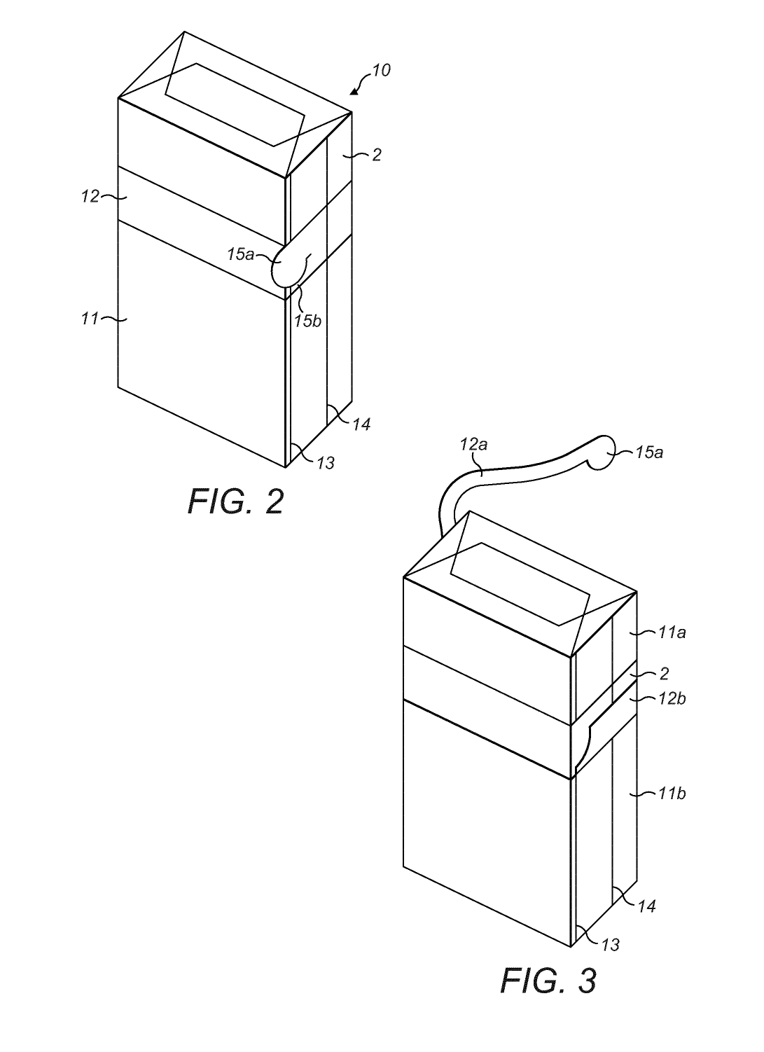

The wrapper 10 is shown fully wrapped around a pack 1 of smoking articles in FIG. 2. The first and second sides 13, 14 of the film 11 overlap at one side wall 2 of the pack 1 and are heat sealed together. The major tab portion 15a of the tear strip 12 extends across an edge 3 of the pack 1 adjacent the side wall 2 where the first and second sides 13, 14 of the film 11 overlap. The tear strip 12 is disposed on the inside of the film 11 adjacent the pack 1 surface.

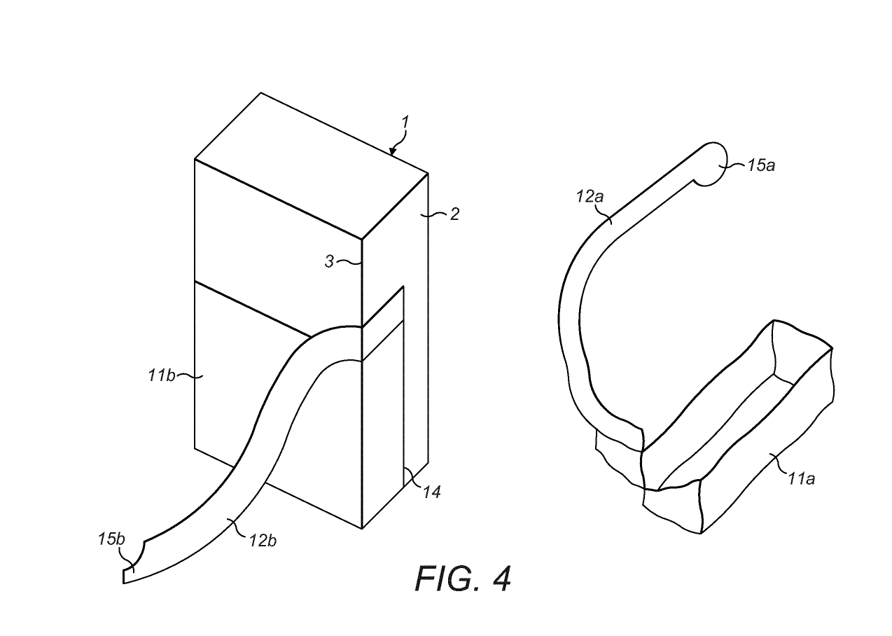

When a user wishes to access the contents of the pack 1, the wrapper 10 must be removed, and the removal process is shown in FIGS. 3-4. First, the user pulls the major tab portion 15a away from the pack 1 which causes a tear in the tear strip 12 to propagate along the length thereof from the nick 17. As the user continues to pull the major tab portion 15a, the tear in the tear strip 12 continues along the length thereof and separates the tear strip 12 into an upper portion 12a and a lower portion 12b. This also causes the film 11 to separate into an upper portion 11a and a lower portion 11b. Since the tear strip 12 is permanently adhered to the film 11, the upper portion 11a of the film 11 comes away from the pack 1 with the upper portion 12a of the tear strip 12, leaving the lower portion 11b of the film 11 and the lower portion 12b of the tear strip 12 still on the pack 1 (see FIG. 4). The user then pulls the minor tab portion 15b away from the pack 1 which initially tears the film 11, and then pulls with it the lower portion 11b of the film 11 away from the pack 1.

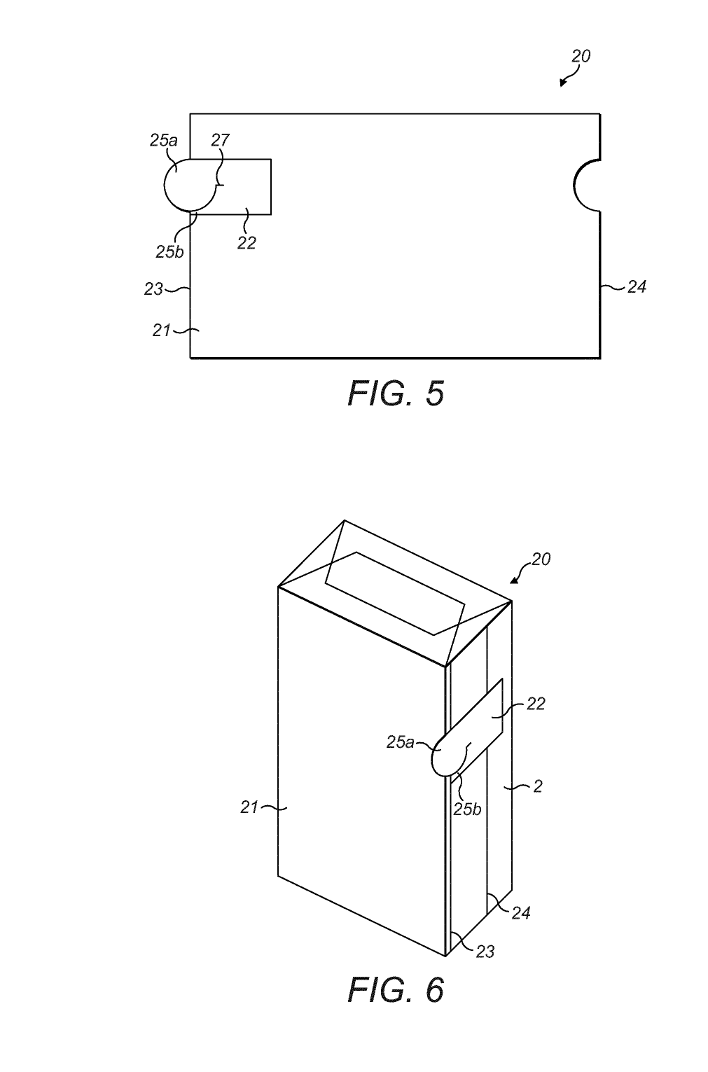

Referring now to FIG. 5, a wrapper 20 of a second embodiment of the invention is shown and comprises a film 21 and a tear label 22 permanently adhered thereto at a first side 23 thereof. The tear label 22 is configured with a first tab portion 25a and a second tab portion 25b which extend beyond the first side 23 of the film 21. The first tab portion 25a and second tab portion 25b meet at a cut or nick 27 that extends a small distance across the film 21 towards a second side 24 of the film 21 opposite the first side 23.

The wrapper 20 is shown fully wrapped around a pack 1 of smoking articles in FIG. 6. The first and second sides 23, 24 of the film 21 overlap at one side wall 2 of the pack 1 and are heat sealed together at the overlap. The tab portions 25a, 25b of the tear strip 22 extend across an edge 3 of the pack 1 adjacent the side wall 2 where the first and second sides 23, 24 of the film 21 overlap. The tear label 22 extends across the heat sealed overlap of the film 21.

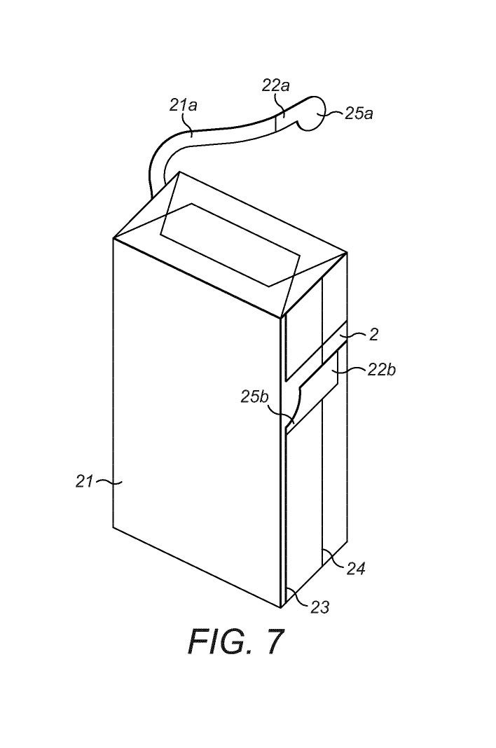

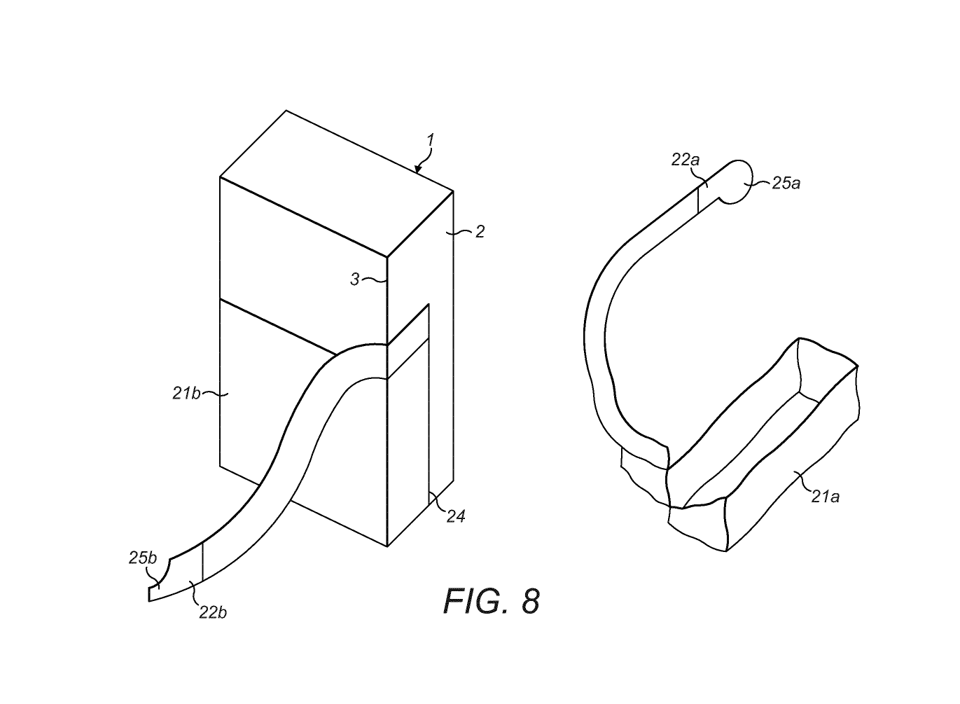

As with the first embodiment of the invention, the wrapper 20 must be removed when a user wishes to access the contents of the pack 1, and the removal process is shown in FIGS. 7-8. First, the user pulls the first tab portion 25a away from the pack 1 which causes a tear in the tear label 22 to propagate along the length thereof from the nick 27 and ensures the tear extends through the heat sealed overlap portion of the film 21, as the heat seal offers increased resistance to tearing of the film compared to the unsealed portions of the film 21. As the user continues to pull the first tab portion 25a, the tear reaches the end of the tear label 22 and continues around the pack 1 in the film 21 alone. The tear label 22 separates into an upper portion 22a and a lower portion 22b and as the upper tear label 22a is continued to be pulled, the film 21 separates into an upper portion 21a and a lower portion 21b along the continuing tear line. Since the tear label 22 is permanently adhered to the film 21, the upper portion 21a of the film 21 comes away from the pack 1 with the upper portion 22a of the tear label 22, leaving the lower portion 21a of the film 21 and the lower portion 22b of the tear label 22 still on the pack 1. The user then pulls the second tab portion 25b away from the pack 1 which initially tears the film 21, and then pulls with it the lower portion 21b of the film 21 away from the pack 1.

The above configurations of wrapper 10, 20 enable the wrapper 10, 20 to be completely, cleanly and efficiently removed from the pack 1 in two parts using respective tear strip portions 12a, 12b or tear label portions 22a, 22b. In the embodiments shown, neither the tear strip 12 nor the tear label 22 includes any additional lines of weakening, extending from the respective nick 17, 27 or otherwise, to facilitate the tearing of the tear strip 12/tear label 22. This provides a cleaner appearance to the packaging and, in use during wrapper removal, the tear in the tear strip 12/tear label 22 generally continues along the length thereof in a desired direction. The material of the tear strip 12/tear label 22 may be an oriented material—that is, a material which is produced having an internal structure giving it increased strength in a certain direction. In the case of the tear strip 12/tear label 22, the material may be stronger in the transverse direction and weaker in the longitudinal direction, such that a tear propagating from the nick 17, 27 would continue in a straight line through the material and not deviate towards and/or through the lateral edges of the tear strip 12/tear label 22.

In addition to the above, the film 11, 21 may be an oriented film can relatively easily tear in one direction and such a tear will propagate in a straight line through the film, but the tear will generally not deviate from this line, and the film offers increased resistance to tearing in any other direction. Accordingly, using an oriented film facilitates the tears propagated from the nicks 17, 27 to follow a straight path around the pack perimeter, especially in the variant shown in FIGS. 5-8 since there is no reinforcing tear strip attached to the film 11 around the entire pack perimeter.

Alternative configurations of tear strip 12/tear label 22 are intended to fall within the scope of the invention, in which the tab portions may be differently shaped whilst still enabling the tear strip/tear tape to tear into two portions to respectively pull away first and second portions of the film from a pack. Such an alternative configuration is shown in FIG. 1B which shows a wrapper 10′ of a variation of the first embodiment of the invention comprising a film 11′ and a tear strip 12′ configured with an upper tab portion 15a′ and a lower tab portion 15b′, both of which extend beyond a first side 13′ of the film 11′. The two tab portions 15a′, 15b′ together are shaped in a generally sideways ‘m’ shape, with a v-shaped incision or nick 17′ between them to facilitate a tear propagating from the nick 17′ when the wrapper 10′ is removed from a pack in the manner described above.

In FIGS. 1-8, the wrappers 10, 10′, 20 are shown configured such that, when the pack is viewed from above, the tear strips 12, 12′ or tear label 22 tear around the perimeter of the pack in an anti-clockwise direction, or from left to right across the front (first major face of the pack the tear encounters) of the pack. However, it will be appreciated that the invention is not intended to be limited to this particular configuration and may equally be arranged in an opposite configuration such that the tear strips 12, 12′ or tear label 22 tear around the perimeter of the pack in a clockwise direction when viewed from above, such that, across the first major face of the pack the tear encounters, the tear proceeds from the right to the left side.

Referring now to FIG. 9, a wrapper 30 of a third embodiment of the invention is shown wrapped around a pack 1 of smoking articles. As with the first and second embodiments of the invention described above, the wrapper 30 comprises a film 31 heat sealed at an overlap at a side wall 2 of the pack 1, and a tear strip 32 permanently adhered to the film 31 and extending from a first side 33 thereof to an opposite second side 34. The tear strip 32 is disposed on the inside of the film 31 adjacent the pack 1 surface. The tear strip 32 has a first tab portion 35a and a second tab portion 35b which meet at a v-shaped nick 37 (shown in FIG. 9 by the angled edges of the two adjacent corners of the tab portions 35a, 35b). The tear strip 32 does not include a line of weakening extending along its length and only the nick 37 is provided from which a tear may propagate.

As with the first and second embodiments of the invention, the wrapper 30 must be removed when a user wishes to access the contents of the pack 1, and the removal process is as described previously with reference to the first embodiment of the invention and so will not be repeated here. Again, for the same reasons as given above, the tear strip 32 and/or the film 31 may comprise an oriented material.

A pack including a wrapper 50 of a fourth embodiment of the invention is shown in FIG. 10 and comprises a film 51, heat sealed around the pack 1, two tear strips 52a, 52b permanently adhered to the film 51 and disposed between the film 51 and the pack 1, and each having respective tab portions 55a, 55b at one remote end. The two tear strips 52a, 52b are spaced apart from each other to define a middle portion 51c of film between them.

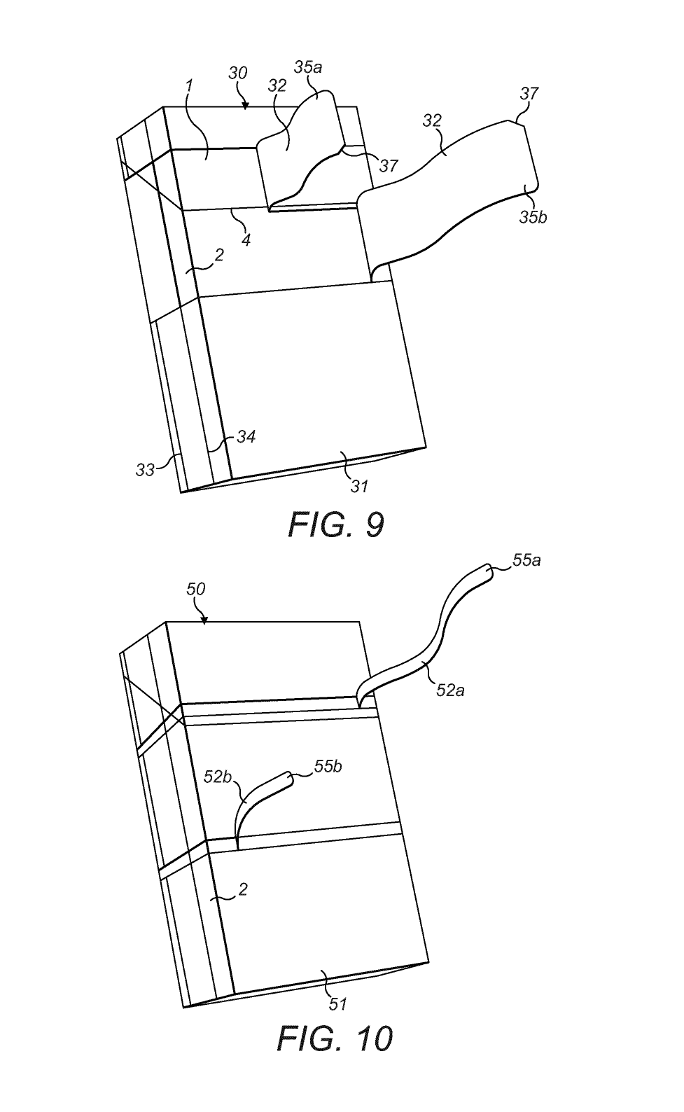

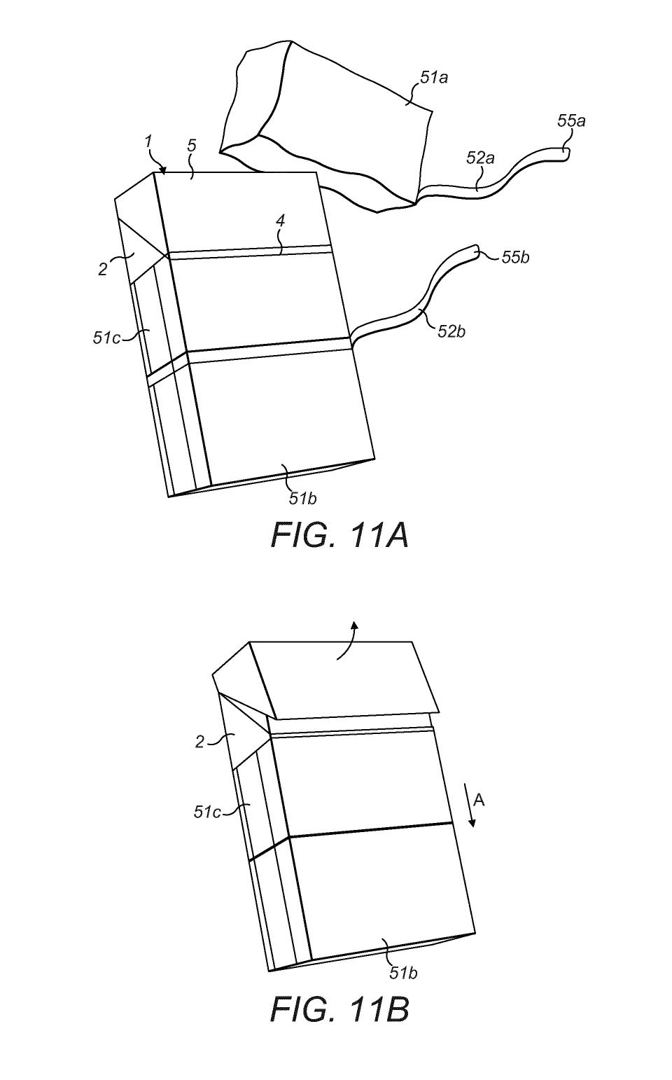

Removal of the wrapper 50 involves pulling the tab portion 55a of the first tear strip 52a to detach it from around the pack 1 (shown in FIG. 11A) which tears the film 51 with it, causing an upper portion 51a of the film 51 to separate from the remainder of the film 51 and to come away from the pack 1 with the first tear strip 52a. This leaves middle and lower portions 51c, 51b of the film 51 and the second tear strip 52b still on the pack 1 (shown in FIG. 11A). The user then pulls the tab portion 55b of the second tear strip 52b away from the pack 1 which initially tears the film 51, and then pulls with it the lower portion 51b of the film 51 away from the pack 1.

There then remains only the middle portion 51c of the film 51 around the middle of the pack 1. It can be seen from FIGS. 10 and 11A that the upper edge of the middle portion 51c of the film 51 is higher than the shut line 4 of a lid 5 of the pack 1 so that the lid 5 cannot be opened. In this way, the middle portion 51c of the film 51 can act as a locking sleeve, preventing opening of the lid 5 of the pack 1 until the middle portion 51c of the film 51 is slid downwards in the direction of arrow A (see FIG. 11B) to below the shut line 4 of the lid 5.

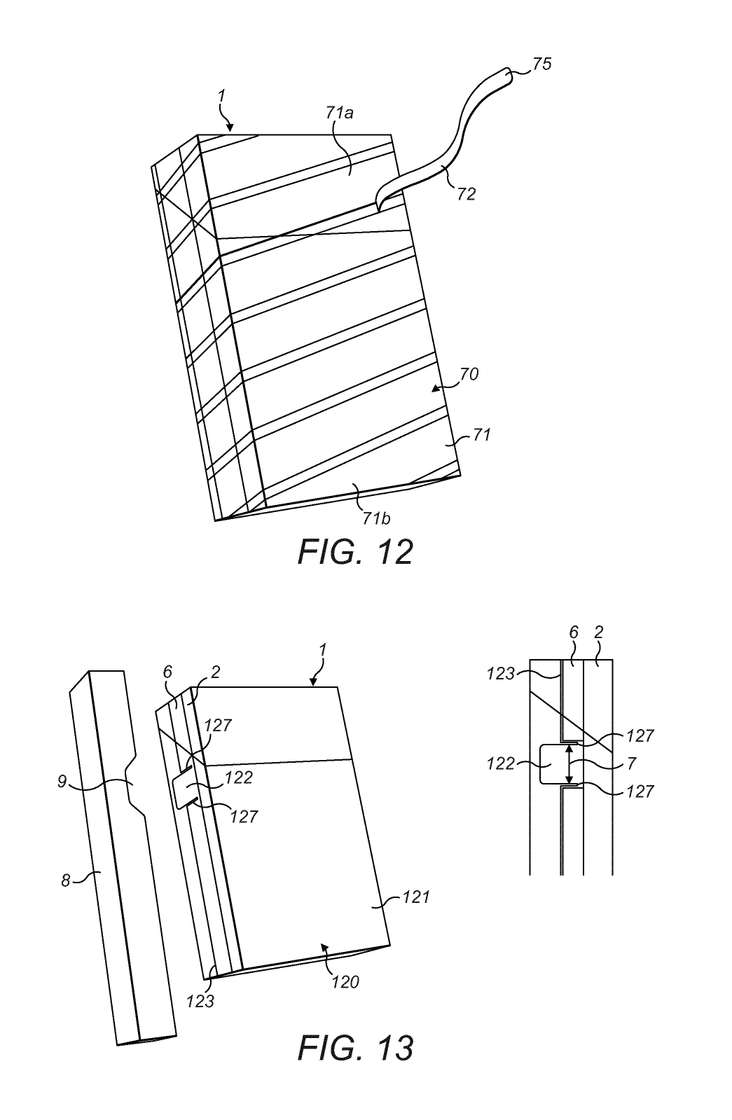

A pack 1 including a wrapper 70 of a fifth embodiment of the invention is shown in FIG. 12 and comprises a film 71, heat sealed around the pack 1 as described previously, and a tear strip 72 extending around the perimeter of the pack 1, permanently adhered to the film 71 between the film 71 and the pack 1, and having a tab portion 75 at one remote end which is not adhered to the underlying film 71. One difference between the wrapper 70 of the fifth embodiment of the invention and those described previously is that the tear strip 72 is disposed around the pack 1 at an acute angle relative to the longitudinal axis of the pack 1 on the major front and rear faces thereof, so that when the tear strip 72 is pulled to separate the film 71 into an upper portion 71a and a lower portion 71b, the line of separation runs in a diagonal direction across the pack 1 front and rear faces. In the embodiment shown in FIG. 12, the tear strip 72 is angled upwards from left to right across the front face of the pack, extends transversely across the right side of the pack parallel to the top and bottom faces, and then runs downwards across the rear face of the pack 1 such that the end of the tear strip 72 distal from the tab portion 75 is adjacent the tab portion on one side of the pack 1.

As with previous embodiments, the upper portion 71a of the film 71 comes away from the pack 1 with the tear strip 72, leaving the lower portion 71b of the film 71 still on the pack 1, which the user may leave in place during use, or may slide off the pack 1.

An alternative configuration of the tear strip 72 of the embodiment shown in FIG. 12 is intended to be encompassed within the scope of the invention, in which the tear strip 72 continues to extend upwards across the front and rear major faces of the pack, so that the single tear strip 72 spirals around the pack perimeter over part or all of the pack height. In such an embodiment, the tab portion 75 may be located at the top or bottom of the pack, and as the tear off tape is pulled, it unwinds around the pack 1 and the film 71 is thereby removed in its entirety in a single unwrapping step.

A pack 1 with a wrapper 120 of a sixth embodiment of the invention is shown in FIG. 13, and comprises a film 121, heat sealed along a seam 6 at an overlap of the film 121 at a side wall 2 of the pack 1, and a portion of an edge 123 of the film 121 on the side wall 2 is formed as a tear tab 122 extending beyond a remaining linear edge 123 of the film 111. The edge 123 of the film 121 includes a pair of nicks 127 either side of the tear tab 122.

One difference between the wrapper 120 of the sixth embodiment of the invention and that of the previous embodiments is that there is no reinforcing tear strip or tear label attached to and reinforcing the film 121. Instead, the tear tab 122 is only a shaped part of the film. Another difference is that the seam 6 does not extend along the entire height of the side 2 of the pack 1, but includes an un-sealed section 7 where the tear tab 122 is located, such that the tear tab 122 is not sealed down to the underlying film 121. This can be achieved by a heat sealing plate 8 (shown schematically in FIG. 13), which applies heat to the overlapped portions of film 121 on the side 2 of the pack 1 to create the seal 6, including a recess 9 corresponding to the position of the tear tab 122 on the side 2 of the pack 1, so that the no heat seal is formed at the location of the recess 9. In an alternative embodiment of the invention, the heat seal may not be absent entirely in the region of the tear tab 122, but instead may be of reduced width compared to the seal along the rest of the overlapping portion of the film 121, so that a weakened section of heat seal 6 is provided to facilitate the tear tab 122 peeling away from the pack 1 when the wrapper 120 is to be removed. Also, the tear tab 122 may additionally comprise a reinforcing label which may be printed or adhered thereto.

To remove the wrapper 120 from the pack 1, a user pulls the tear tab 122 away from the pack, which causes a tear to propagate from each nick 127 in a transverse direction of the pack 1. As there is no heat seal in the region of the tear tab 122 (or a weakened seal), no additional reinforcement to the film 121 is required over this area for a straight tear to be generated. Thereafter, the tears propagated from each nick 127 continue in parallel around the pack to create a tear strip which separates an upper film portion from a lower film portion, the upper portion coming away from the pack 1 attached to the tear strip, and the lower portion can then be removed from the pack 1 to allow access to the pack contents. The wrapper 120 of the sixth embodiment of the invention is also particularly appropriate to comprise an oriented film 121, for the same reasons given above.

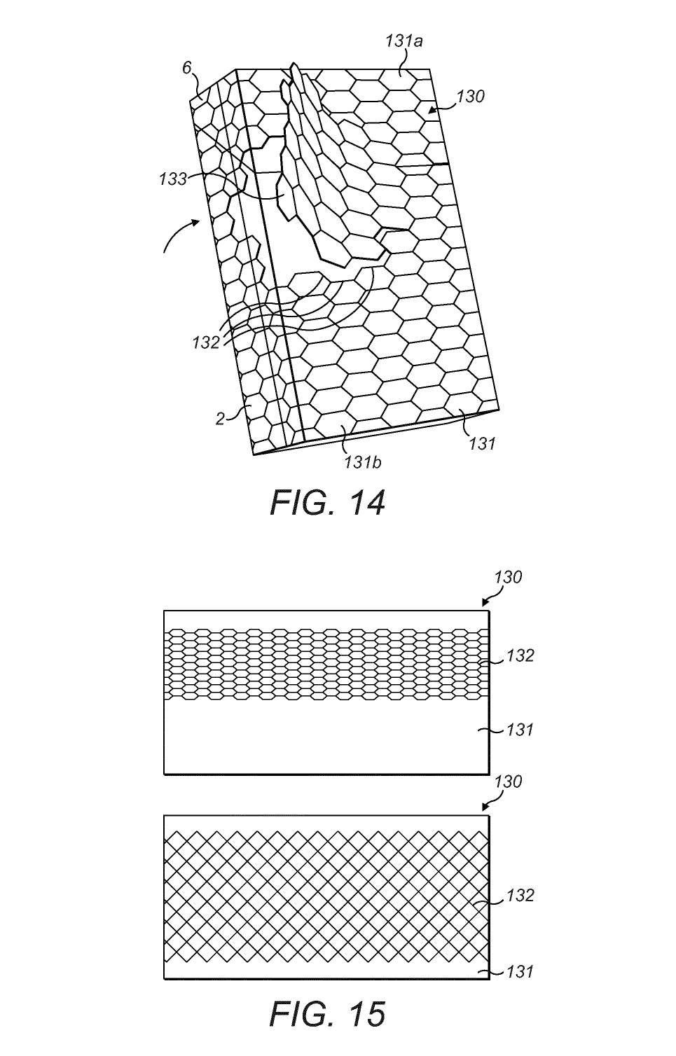

A pack 1 including a wrapper 130 of a seventh embodiment of the invention is shown in FIG. 14 and comprises a film 131 heat sealed along a seam 6 at an overlap of the film 131 at a side wall 2 of the pack 1. The film 131 is formed with a pattern of micro-lines of weakening 132 its surface. These are shown in a tessellating hexagon cell pattern in FIG. 14, although other configurations are intended within the scope of the invention, such as a cross-hatch pattern. Furthermore, FIG. 14 shows the pattern extending over the entire film 131, whereas the pattern may alternatively extend in a band across the width of the film 131. Both such alternative embodiments are shown in FIG. 15.

To remove the wrapper 130 from the pack 1, a user grasps a portion of the film 131 at an edge thereof proximate the seam 6 and pulls it away from the pack 1. A tear in the film 131 then propagates in a tear path corresponding to the lines of weakening 132 to separate the film 131 into an upper portion 131a and a lower portion 131b, with tear edges corresponding to the pattern of the lines of weakening. The tear follows a generally transverse path around the pack, while following the lines of weakening 132, rather than deviating up or down the pack 1 between the lines of weakening, so that a tear strip 133 separates from the remainder of the film 131, and the upper portion 131a of the film 131 comes away from the pack with the tear strip 133, leaving the lower portion 131b still on the pack 1 to be removed separately. As the film 131 tears, it may produce a distinctive audible sound, as the tear continues along transverse sections of the lines of weakening 132, then along angled portions of the lines of weakening.

The lines of weakening 132 may be of uniform weakness, although it is intended within the scope of the invention that some lines of weakening along which the tear strip 133 is intended to be formed, may be formed with increased weakness to allow the tear strip 133 to separate from the remainder of the film 131 along an intended tear path.

Although embodiments of the invention have been shown and described above in relation to wrappers enveloping a single pack of smoking articles, such wrappers of the invention are intended to be usable as an outer wrapping around alternative configurations of packaging, such as around multiple packs of smoking articles bundled together, either ‘naked’ or in a carton holding, for example, 10 or 20 packs of smoking articles, or around tins or other containers, such as snus containers. Furthermore, such container(s) to be wrapper with wrappers of the invention, do not necessarily need to be parallelepiped in shape, and may comprise other shapes, for example, cylindrical container(s). The various embodiments of the invention are shown and described above as wrappers for packs of smoking articles, or smoking article packaging having various embodiments of outer wrapper. However, the invention is not intended to be limited to such use and it will be appreciated that the invention is equally applicable to wrappers and packaging for any other, non-tobacco industry use.

In the embodiments described above, the wrappers are described as being heat sealed along a seam at an overlap of the wrapper. However, the invention is not intended to be limited to such sealing means, and alternatives are intended within the scope of the invention, such as glue or other adhesive. Furthermore, some of the embodiments are described above as comprising oriented film, although such film may be used as the film in wrappers of any of the embodiments of the invention described herein, and may be particularly suitable for wrappers without tear tapes extending around the entire perimeter of a wrapped pack, or those wrappers intended to tear in locations other than directly adjacent the edge of a tear tape.

In the embodiments described above, the tear tape(s) are described as being adhered to the respective film, although the invention is not intended to be limited to such construction and the tear tape(s) may alternatively be heat sealed to the respective film or comprise other means of sealing thereto. Additionally, although in many of the embodiments described above, the tear tapes/labels are described as being provided on the inside surface of the wrapper when wrapped around a pack, the tear tapes/labels may equally be provided on the outside of the respective wrapper.

The film and tear strips of the wrappers of the invention described above may be made of a variety of materials, including, but no limited to, polypropylene, polyvinyl chloride (PVC), cellulose acetate film, polyethylene terephthalate (PET), polyethylene oxide (PEOX), polyethylene, cellophane, Natureflex™ or polyactic acid (PLA). Furthermore, combinations of such materials may be used for the film/tear strip(s)/tear label(s) respectively. In addition, the film and/or the tear strip/tear label material used in the wrappers may be of approximately 200 microns in thickness to approximately 4 microns in thickness.

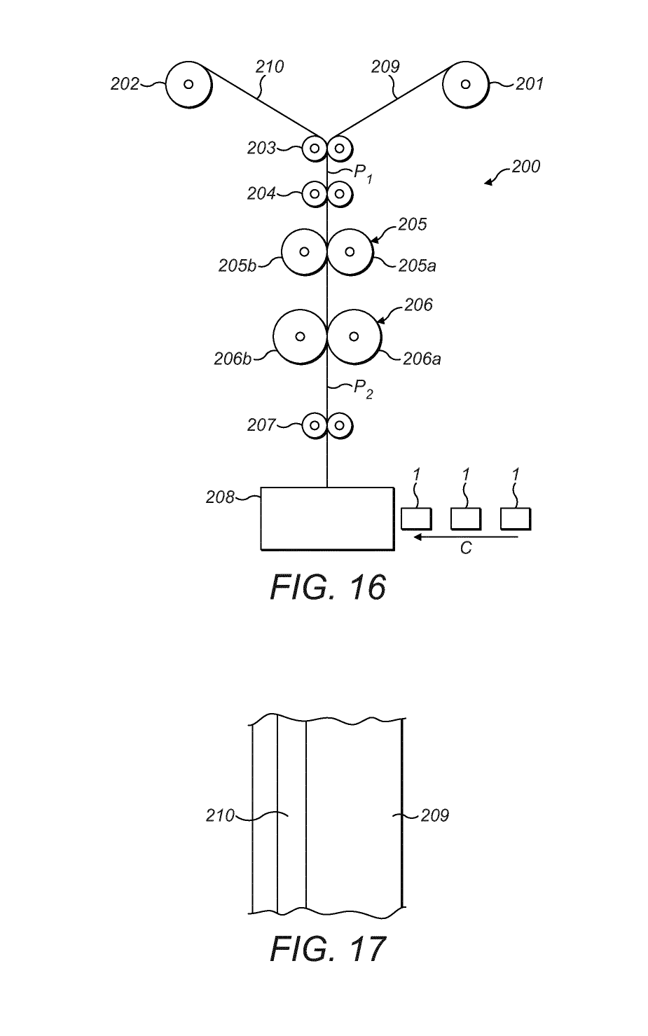

An apparatus 200 for manufacturing a wrapper 10 of the first embodiment of the invention is shown schematically in FIG. 16, and comprises a film bobbin 201 and a tape bobbin 202, a pair of tape application rollers 203, a first pair of guide rollers 204, a first pair of cutting rollers 205, a second pair of cutting rollers 206, a second pair of guide rollers 207, and a wrapping station 208.

A continuous band of film 209 is fed from the film bobbin 201, and a continuous strip of tear tape 210 is fed from the tape bobbin 202 to the tape application rollers 203, where the tear tape 210 is applied to the band of film 209. The tear tape 210 may be provided with an adhesive pre-applied on one side thereof so that it adheres to the band of film 209, or an adhesive application station (not shown) may be provided between the tape bobbin 202 and the tape application rollers 203 to apply adhesive to the tear tape 210 before it comes into contact with the band of film 209.

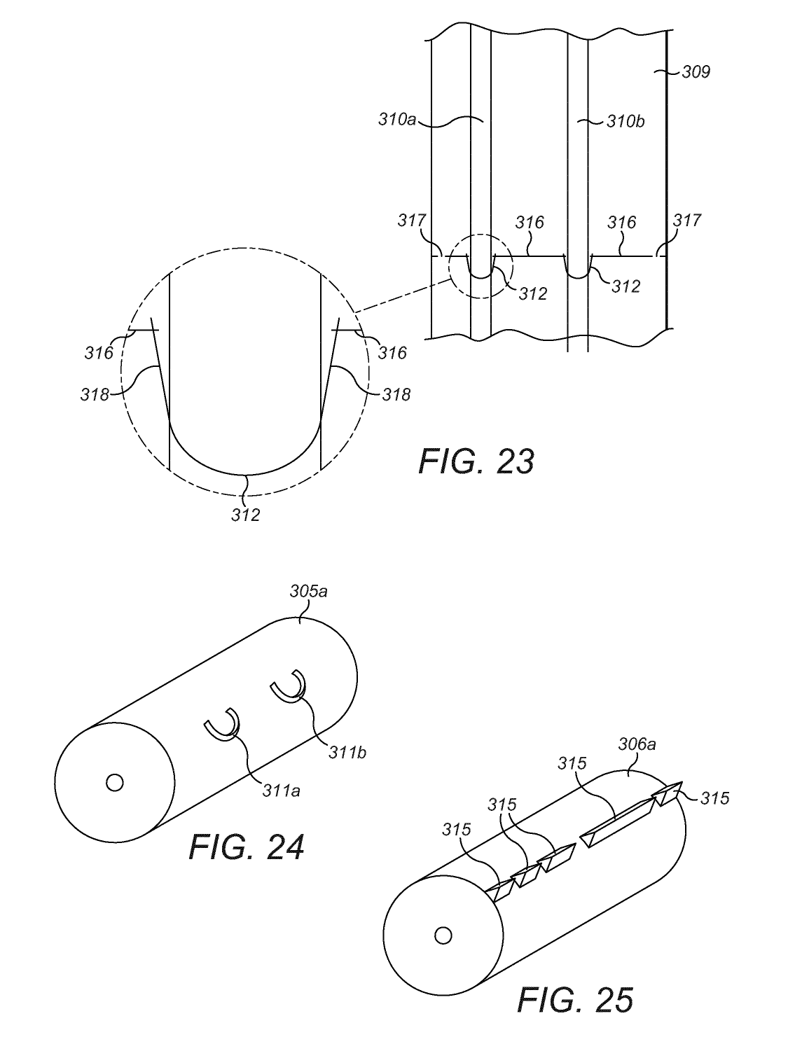

A view of a section of the continuous film 209 with tear tape 210 applied thereto at position P₁ of FIG. 23, is shown in FIG. 17.

After passing the tape application rollers 203, the band of film 209 passes through a first pair of guide rollers 204 which control the speed at which the band of film 209 is fed through the apparatus 200.

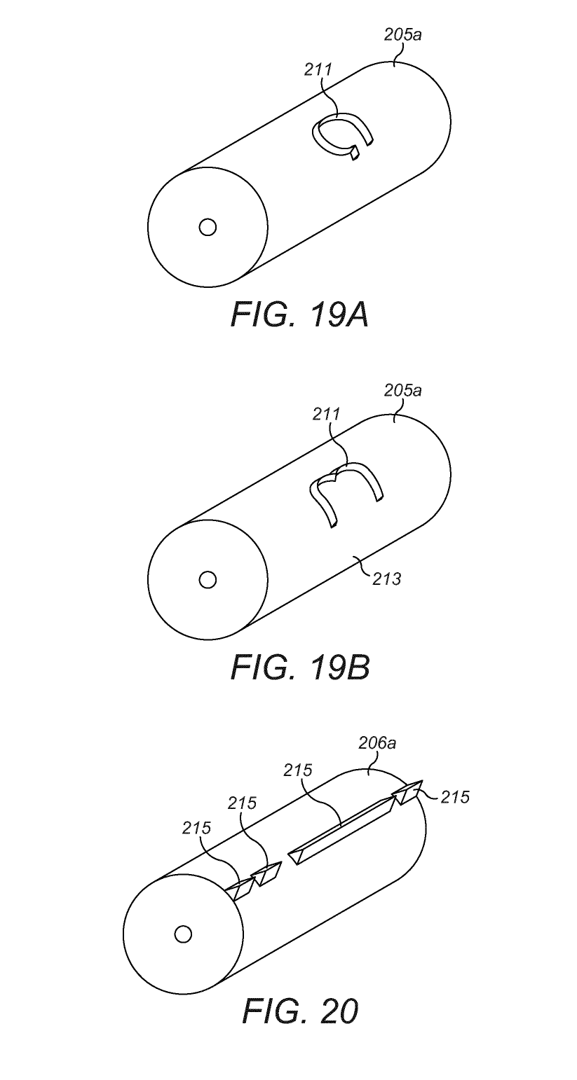

After passing through the first pair of guide rollers 204, the band of film 209 passes through a first pair of cutting rollers 205 comprising a knife roller 205a and a contrast roller 205b. The knife roller 205a includes a knife blade 211 shaped and positioned to form a tab cut 212 in the tear tape 210 to form the major and minor tab portions 15a, 15b, the arcuate cut 16 and the nick 17. Such a knife roller 205a to form these features of the wrapper shown in FIG. 1A is shown in FIG. 19A. An alternative knife roller 205a with a knife blade 211 configured to form the first and second tab portions 15a′, 15b′ of the wrapper shown in FIG. 1B is shown in FIG. 19B. This knife 211 of the knife roller 205a of FIG. 19B is generally ‘m’ shaped.

The knife roller 205a is of a specific diameter and rotates in registration with the band of film 209 and the contrast roller 205b so that it presses the knife 211 against the band of film 209 and attached tear tape 210 onto the contrast roller 205b at desired intervals as the band of film 209 passes between the first pair of cutting rollers 205, to form the cuts 212 at the desired intervals along the band of film 209.

The band of film 209 then passes through the second pair of cutting rollers 206, which includes a knife roller 206a and a contrast roller 206b. The knife roller 206a includes a series of straight knife blades 215 configured to cut across the band of film 209 as it passes through the second pair of cutting rollers 206, to form linear cuts 216 therein to form individual wrappers 10, 10′ from the continuous band of film 209. The second knife roller 206a is shown in FIG. 20. The cuts 216 extend across the band of film 209 and the knife blades 215 are spaced and configured to leave a small uncut tab region 217 proximate either side of the band of film 209 to allow the film 209 to be pulled though the apparatus 200 to the subsequent processing stages, but which tab regions 217 can be broken to separate individual wrappers 10, 10′ from the continuous band of film 209 in a later pack wrapping step (described in more detail below).

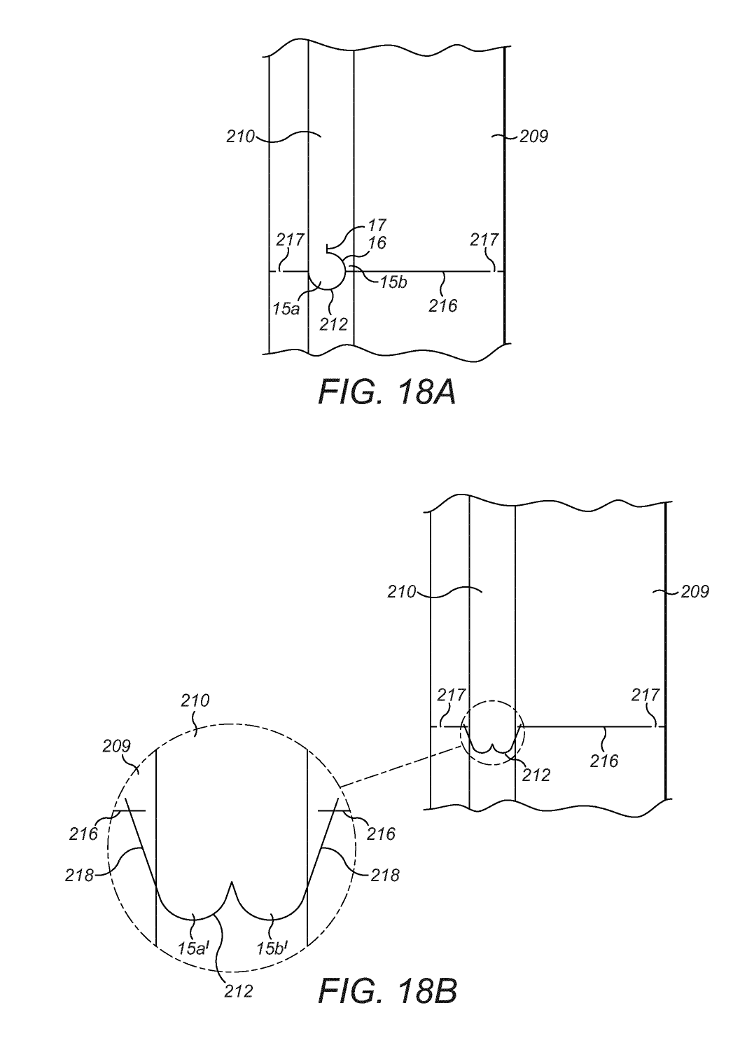

The second cutting rollers 206 are sized, spaced and configured in registration with the first cutting rollers and also the conveyance speed of the band of film 209, so that the linear cuts 216 are formed in specific correspondence to the location of the tab cuts 212. The knife blades 215 are configured not to cut across the tab regions 15a, 15b, 15a′, 15b′ formed in the previous cutting step. The band of film 209 formed after leaving the second pair of cutting rollers 206 (at point P₂ in FIG. 16) is shown in FIGS. 18A and 18B, which respectively show the bands of film 209 for forming each variant of wrappers 10, 10′ of the first embodiment of the invention shown in FIGS. 1A and 1B. Referring to the ‘m’ shaped cut 212 formed in the wrapper 10′ of FIGS. 1B and 18B, it is noted that the linear cuts 216 cross the tails 218 of the ‘m’ cut in the film 209 to ensure a clean separation of the tabs 15a′, 15b′ of the tear strip 12 from the preceding wrapper 10′, but the linear cuts 216 do not extend as far as the tear strip 210 so as to avoid weakening the tabs 15a′, 15b′ or tear strip 12 of the finished wrapper 10′.

It will be appreciated by one skilled in the art that a variety of different shaped notches can be achieved by changing the design of the notching knife (i.e. the knives 211 of the knife rollers 205a) accordingly. For example, a variation of the tab cut 212 in the tear tape 210 shown in FIGS. 1A and 18A may include a portion of the cut 212 on the opposite side of the second tab portion 15b extending tangentially into the adjacent film 11/209 instead of alongside and parallel to the edge of the tear tape 210, such that it crosses the straight cut 216 to ensure a clean separation of consecutive wrappers 10. Also, the straight cut 216 may not extend all the way to the tear tape 210 after crossing such a tangential cut portion, in the same manner as the straight cut 216 crosses the tail portion 218 of the ‘m’ cut 212 in FIG. 18B, so as to avoid weakening the tab 15a or tear strip 12 of the finished wrapper 10, and to allow a degree of manufacturing tolerance in the position of the film 209 and tear tape 210 relative to the respective knife rollers 205a, 206a.

After the cut band of film 209 exits the second pair of cutting roller 206, it passes through a further pair of guide rollers 207 to be fed into a wrapping station 208 where a succession of packs of smoking articles 1 are fed in the direction of arrow C, each one plunging into the mid point of the end-most wrapper 10/10′, which causes the tab regions 217 to sever, separating the wrapper 10/10′ from the band of film 209 and the pack 1 is then wrapped and sealed with the wrapper 10/10′.

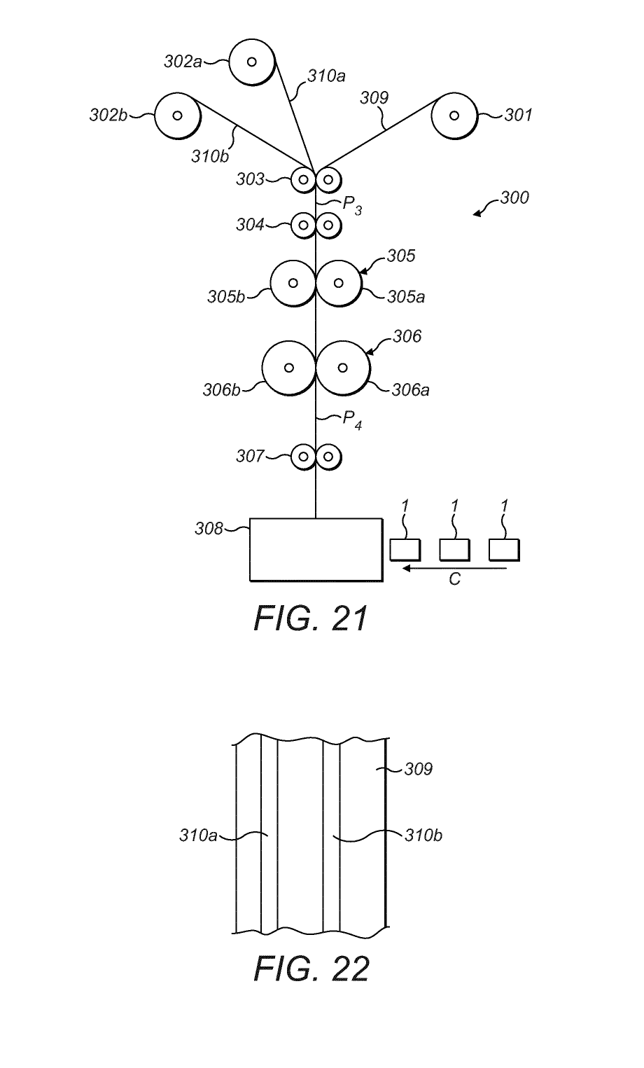

An apparatus 300 for manufacturing a wrapper 50 of the fourth embodiment of the invention is shown schematically in FIG. 21, and is similar to the apparatus 200 described above, and comprises a film bobbin 301, a pair of tape application rollers 303, a first pair of guide rollers 304, a first pair of cutting rollers 305, a second pair of cutting rollers 306, a second pair of guide rollers 307, and a wrapping station 308. However, since the wrapper 50 of the fourth embodiment of the invention comprises two separate tear strips 52a, 52b, then the apparatus 300 comprises first and second tape bobbins 302a, 302b.

An ‘m’-shaped single knife may be used to cut the delineating tab cuts, as shown in FIG. 19B, instead of forming the individual tab cuts by separate knife blades, as shown in FIG. 24 (described in more detail hereafter).

A continuous band of film 309 is fed from the film bobbin 301, and continuous strips of tear tape 310a, 310b are fed from the first and second tape bobbins 302a, 302b to the tape application rollers 303, where the tear tapes 310a, 310b are applied to the band of film 309. As described with respect to the previous apparatus 200, the tear tapes 310a, 310b may have adhesive pre-applied on one side thereof or adhesive may be applied thereto at an adhesive application station (not shown) between the tape bobbins 302a, 30b and the tape application rollers 303.

A view of a section of the continuous film 309 with tear tapes 310a, 310b applied thereto at position P₃ of FIG. 21, is shown in FIG. 22.

After passing the tape application rollers 303, the band of film 309 passes through a first pair of guide rollers 304 which control the speed at which the band of film 309 is fed through the apparatus 300.

The band of film 309 then passes through a first pair of cutting rollers 305 comprising a knife roller 305a and a contrast roller 305b. The knife roller 305a, shown in FIG. 24, includes a pair of knife blades 311a, 311b shaped and positioned to form cuts 312 in the tear tapes 310a, 310b and film 309 as described previously, although the knife blades 311a, 311b are configured to form generally C-shaped cuts.

The band of film 309 then passes through the second pair of cutting rollers 306, which includes a knife roller 306a and a contrast roller 306b. The second knife roller 306a is shown in FIG. 25 and includes a series of straight knife blades 315 configured to cut across the band of film 309 as described previously. As before, the cuts 316 extend across the band of film 309 but small uncut tab regions 317 are left at either side of the band of film 309. Also, the knife blades 315 are configured not to cut across the tab regions 55a, 55b, and the band of film 309 formed after leaving the second pair of cutting rollers 306 (at point P₄ in FIG. 21) is shown in FIG. 23, which shows the band of film 309 for forming the wrapper 50 of the fourth embodiment of the invention shown in FIGS. 10, 11A and 11B. Referring to the ‘C’ shaped cut 312 formed in the wrapper 50, the linear cuts 316 cross the tails 318 of the ‘C’ cut in the film 309 to ensure a clean separation of the tabs 55a, 55b of the tear strips 52a, 52b from the preceding wrapper 50, but the linear cuts 316 do not extend as far as the tear strips 310a, 310b so as to avoid weakening the tabs 55a, 55b or tear strips 52a, 52b of the finished wrapper 50.

After the cut band of film 309 exits the second pair of cutting roller 306, it passes through a further pair of guide rollers 307 to be led into a wrapping station 308 for individual packs 1 to be wrapped as described previously.

Although in the embodiments of apparatuses of the invention described above, the second knife rollers 206a, 306a are configured to leave uncut tab regions 217, 317 proximate the edges of the band of film 209, 309, the invention is not limited to this configuration and the linear cuts 216, 316 may extend entirely to the edges of the band of film 209, 309 to fully separate individual wrappers 10, 10′, 50 from each other prior to the pack wrapping stage.

In the apparatuses of the invention described above, the cuts are formed in the band of film 209, 309 by pairs of cutting rollers 205, 206, 305, 306. However, the invention is not limited to this particular embodiments and instead, the band of film 209, 309 may pass between a knife mounted on a cam, and a bearing or roller, such that the knife reciprocates to form the desired cuts intermittently along the passing band of film 209, 309. In such embodiments, the knife may be mounted on a plate to stamp the cuts into the film.

In the apparatus 300 in which a plurality of tear tapes 310a, 310b are provided on the film 309, the respective tear tapes 310a, 310b are fed from separate bobbins 302a, 302b. However, the invention is not intended to be limited to such a configuration of apparatus, and multiple tear tapes could alternatively be supplied from a single bobbin. Furthermore, a single wide strip of tear tape material could be fed to a splicing roller or other splicing means, which could cut the tear tape material lengthwise into the desired number of tear tapes, which could subsequently be fed to the film to be adhered thereto.

As used herein, the term “smoking article” includes smokeable products such as cigarettes, cigars and cigarillos whether based on tobacco, tobacco derivatives, expanded tobacco, reconstituted tobacco or tobacco substitutes and also heat-not-burn products. The smoking article may be provided with a filter for the gaseous flow drawn by the smoker.

A tobacco industry product refers to any item made in, or sold by the tobacco industry, typically including a) cigarettes, cigarillos, cigars, tobacco for pipes or for roll-your-own cigarettes, (whether based on tobacco, tobacco derivatives, expanded tobacco, reconstituted tobacco or tobacco substitutes); b) non-smoking products incorporating tobacco, tobacco derivatives, expanded tobacco, reconstituted tobacco or tobacco substitutes such as snuff, snus, hard tobacco, and heat-not-burn products; and c) other nicotine-delivery systems such as inhalers, lozenges and gum. This list is not intended to be exclusive, but merely illustrates a range of products which are made and sold in the tobacco industry.

In order to address various issues and advance the art, the entirety of this disclosure shows by way of illustration various embodiments in which the claimed invention(s) may be practiced and provide for superior packaging wrappers. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further un-described alternate embodiments may be available for a portion is not to be considered a disclaimer of those alternate embodiments. It will be appreciated that many of those un-described embodiments incorporate the same principles of the invention and others are equivalent. Thus, it is to be understood that other embodiments may be utilized and modifications may be made without departing from the scope and/or spirit of the disclosure. As such, all examples, implementations, and/or embodiments are deemed to be non-limiting throughout this disclosure. Also, no inference should be drawn regarding those embodiments discussed herein relative to those not discussed herein other than it is as such for purposes of reducing space and repetition. Various embodiments may suitably comprise, consist of, or consist essentially of, various combinations of the disclosed elements, components, features, parts, steps, means, etc. Some of the disclosed features, elements, implementation, etc., may be mutually contradictory, in that they cannot be simultaneously present in a single embodiment. Similarly, some features are applicable to one aspect of the disclosure, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, function, features, structural, and/or other aspects of the disclosure are not to be considered limitations on the disclosure as defined by the claims or limitations on equivalents to the claims.

1. A wrapper comprising a film having a reinforcing tear strip extending at least partially across the film, the tear strip including an incision, and wherein no lines of weakening are provided in the tear strip to assist the tearing thereof other than the incision, the wrapper configured such that, when a first portion of the tear strip on one side of the incision is pulled away from a second portion of the tear strip on the other side of the incision, a tear will propagate from the incision along the length of the tear strip and through the film so that the tear strip and film separate into two portions with a first portion of the film attached to the first tear strip portion, and a remaining, second portion of the film attached to the second tear strip portion.

2. A wrapper according to claim 1 wherein the film comprises a first side and a second, opposite side, and the reinforcing tear strip extends from the first side of the film.

3. A wrapper according to claim 2 wherein the incision is formed proximate the first side of the film.

4. A wrapper according to claim 2 or claim 3 wherein the film comprises a second side opposite said first side, and the tear strip extends entirely across the film from the first side to the second side.

5. A wrapper according to claim 2 or claim 3 wherein the film comprises a second side opposite said first side, and the tear strip extends only partially across the film from the first side towards the second side.

6. A wrapper according to any of claims 2-5 wherein the tear strip includes at least one tab portion projecting from the first side of the film.

7. A wrapper according to claim 6 wherein the tear strip includes two tab portions, one disposed either side of the incision.

8. A wrapper according to claim 7 wherein the two tab portions together define a substantially ‘m’ shaped end of the tear strip.

9. A wrapper according to any preceding claim wherein the cut comprises a substantially v-shaped nick in the tear strip.

10. A wrapper according to any preceding claim wherein the tear strip is adhered to the film.

11. A wrapper according to any preceding claim wherein the tear strip comprises an oriented material.

12. A wrapper according to any preceding claim wherein material of the wrapper comprises an oriented film.

13. A wrapper according to any preceding claim comprising only one single tear strip.

14. A package comprising at least one container enveloped in a wrapper according to any of claims 1 to 13, wherein the wrapper can be entirely removed from the pack by pulling a first portion of the tear strip to propagate a tear from the incision along the length of the tear strip and through the film to remove a first portion of the film attached to the first tear strip portion, and the remaining, second portion of the film can be removed from the pack by pulling away with the second tear strip portion.

15. A wrapper comprising a film having a plurality of reinforcing tear strips extending at least partially across the film, each tear strip including tab portion, the wrapper configured such that pulling the tab of a first tear strip causes a tear to propagate through the film to separate a first portion of the film attached to the first tear strip, from the remainder of the film, and pulling the tab of a second tear strip causes a second tear to propagate through the film to define a second portion of the film attached to the second tear strip.

16. A wrapper according to claim 15 wherein the first and second tear strips are spaced from each other such that a third portion of the film is defined between them and which remains when the first and second tear strips are pulled to separate the first and second portions of the film, attached to the first and second tear strips respectively, from the third portion of the film.

17. A wrapper according to claim 15 or claim 16 wherein the tabs and the first and second tear strips are configured so that the tear each tear strip causes in the film when the respective tab is pulled, extends in a substantially opposite direction to each other.

18. A wrapper according to claim 15 or claim 16 wherein the film comprises a first side and a second, opposite side, and the reinforcing tear strips extend from one of the first and second sides of the film.

19. A wrapper according to claim 18 wherein the tabs of the first and second tear strips are located on opposite sides of the film so that the tear each tear strip causes in the film when the respective tab is pulled, extends in a substantially opposite direction to each other.

20. A wrapper according to any of claims 15 to 19 wherein a line of weakening is formed in the film between the first and second tear strips.

21. A wrapper according to any of claims 15 to 20 wherein each tab portion is delimited from the respective film edge by an incision.

22. A wrapper according to any of claims 15-21 wherein the tear strips are adhered to the film.

23. A package comprising at least one container enveloped in a wrapper according to any of claims 15 to 22.

24. A pack enveloped in a wrapper of claim 16, wherein the pack is parallelepiped and comprises a base and a hinged lid which defines a shut line on a front face of the pack, wherein the first tear strip is disposed on one side of the shut line and the second tear strip is disposed on an opposite side of the shut line such that when the first and second portions of the film are removed, the third portion remains on the pack overlying the shut line preventing the hinged lid being pivoted open.

25. A package comprising at least one container enveloped in a wrapper, the wrapper comprising a film with overlapping portions which are sealed together, wherein a pull tab is defined in the film in the region of the overlapping portions to facilitate removal of the wrapper by pulling the tab to initiate tearing of the film, and wherein the seal is weakened or interrupted in the region of the pull tab.

26. A package according to claim 25 comprising a plurality of pull tabs formed in the film in the region of the overlapping portions.

27. A package according to claim 25 or claim 26 wherein the seal is weakened by being of reduced width in the region of the, or at least one of the, pull tab(s).

28. A package according to any of claims 25 to 27 wherein the seal is entirely interrupted in the region of the, or at least one of the, pull tab(s).

29. A package according to any of claims 25 to 28 wherein at least one incision is formed in the film adjacent the or each pull tab to facilitate initiating of the tear in the film when the or each pull tab is pulled.

30. A wrapper comprising a film having a plurality of lines of weakening formed in a repeating pattern over at least a portion of the surface area of the film, the wrapper configured such that a portion of the film can be separated from a remaining portion of the film by tearing the film and the tear propagating along the lines of weakening.

31. A wrapper according to claim 30 wherein the repeating pattern comprises a pattern of tessellating polygons.

32. A wrapper according to claim 30 or claim 31 wherein the lines of weakening are unequally weak such that an intended tear path of the film is defined by one or mote lines of increased weakening relative to the remaining lines of weakening.

33. A wrapper according to any of claims 30 to 32 wherein an edge of the film comprising an intended tear initiation point includes one or more pull tabs.

34. A wrapper according to claim 33 wherein the one or more pull tabs comprise a label printed or adhered onto the film.

35. A package comprising at least one container enveloped in a wrapper according to any of claims 30 to 34.

36. A wrapper of any preceding claim wherein the film comprises an oriented film.

37. An apparatus for manufacturing a wrapper for packaging, comprising a supply of film and a supply of reinforcing tear strip material, a pair of rollers through which the film and tear strip material can be fed together to affix the tear strip material to the film, and one or more cutting knives configured to form cuts intermittently through the tear strip and the film as the film is conveyed past the cutting knife/knives, wherein the cutting knife/knives are configured to form linear cuts transversely through the film to divide the film into individual wrappers, and to form tab cuts in the tear strip material proximate the linear cuts to define first and second tab portions at one end of the tear strip of each wrapper, and also form an incision in the tear strip material between each first and second tab portion, and wherein no lines of weakening are provided in the tear strip to assist the tearing thereof other than the incision.

38. An apparatus according to claim 37 wherein the incision formed between the first and second tab portions is configured to enable a tear to propagate from the incision along the length of the tear strip and through the film when the first tab portion is pulled away from the second tab portion.

39. An apparatus according to claim 37 or claim 38 configured to form the tab cuts and first and second tab portions in a single reinforcing tear strip.

40. An apparatus according to any of claims 37 to 39 configured to form the tab cuts extending across the edges of the tear strip into the film adjacent the tear strip.

41. An apparatus according to claim 40 configured to form the linear cuts intersecting the tab cuts in the region of the film adjacent the tear strip, but not to extend into the tear strip.

42. An apparatus according to any of claims 37 to 41 wherein cutting knife/knives are configured to form substantially ‘m’ shaped tab cuts.

43. An apparatus for manufacturing a wrapper for packaging, comprising a supply of film and a supply of reinforcing tear strip material, a pair of rollers through which the film and tear strip material can be fed together to affix two separate portions of tear strip material on the film, and one or more cutting knives configured to form cuts intermittently through the tear strips and the film as the film is conveyed past the cutting knife/knives, wherein the cutting knife/knives are configured to form linear cuts transversely through the film to divide the film into individual wrappers, and to form tab cuts in the tear strips proximate the linear cuts to define a tab portion at one end of each tear strip of each wrapper.

44. An apparatus according to claim 43 configured to provide the pair of tear strips in parallel along the film and transversely spaced from each other.

45. An apparatus according to claims 43 or claim 44 configured to form the tab cuts extending across the edges of the tear strips into the film adjacent the tear strips.

46. An apparatus according to claim 45 configured to form the linear cuts intersecting the tab cuts in the region of the film adjacent the tear strips, but not to extend into the tear strips.

47. A method of manufacturing a wrapper for packaging comprising applying a reinforcing tear strip to a film, forming linear cuts transversely through the film to divide the film into individual wrappers, forming tab cuts in the tear strip material proximate the linear cuts to define first and second tab portions at one end of the tear strip of each wrapper, and forming an incision in the tear strip material between each first and second tab portion, and wherein and no line of weakening is provided in the tear strip to assist the tearing thereof other than the incision.

48. A method according to claims 47 comprising forming the tab cuts and first and second tab portions in a single reinforcing tear strip.

49. A method according to claim 47 or claim 48 comprising forming the tab cuts extending across the edges of the tear strip into the film adjacent the tear strip.

50. A method according to claim 49 comprising forming the linear cuts intersecting the tab cuts in the region of the film adjacent the tear strip, but not extending into the tear strip.

51. A method according to any of claims 47 to 50 comprising forming substantially ‘m’ shaped tab cuts.

52. A method of manufacturing a wrapper for packaging comprising applying two separate portions of a reinforcing tear strip material to a film, forming linear cuts transversely through the film to divide the film into individual wrappers, forming tab cuts in the tear strips proximate the linear cuts to define a tab portion at one end of each tear strip of each wrapper.

53. A method according to claim 52 comprising providing the tear strips in parallel along the film and transversely spaced from each other.

54. A method according to claim 52 or claim 53 comprising forming the tab cuts extending across the edges of the tear strips into the film adjacent the tear strips.

55. A method according to claim 54 comprising forming the linear cuts intersecting the tab cuts in the region of the film adjacent the tear strips, but not extending into the tear strips.

56. A method of manufacturing a packaging comprising enveloping at least one container with a wrapper, overlapping the wrapper along one side of the at least one container, and sealing the overlapping portions together, forming a pull tab in the region of the overlapping portions to facilitate removal of the wrapper by pulling the tab to initiate tearing of the film, and forming the seal with a weakened or interrupted region in the area of the pull tab.

57. A method according to claim 56 comprising forming the seal with a reduced width at the weakened region.

58. A method according to claim 56 comprising forming the seal by interrupting the seal at the weakened region.
